(19) United States
(12) Patent Application Publication
(10) Pub. No.: US 2026/0222467 A1
(43) Pub. Date: Jul. 30, 2026

(54) SYSTEMS AND METHODS OF PROBABILISTIC BOUNCING FOR NETWORK LOAD BALANCING

(71) Applicant: Salesforce, Inc., San Francisco, CA (US)

(72) Inventors: André Kohn, Munich (DE); Sebastian Hofstetter, Munich (DE); Michael Haubenschild, Munich (DE); Moritz Kaufmann, Frickenhausen (DE)

(21) Appl. No.: 19/038,769

(22) Filed: Jan. 28, 2025

(51) Int. Cl. H04L 67/1008; G06F 16/2455; G06F 16/27

(52) U.S. Cl. CPC H04L 67/1008; G06F 16/24552; G06F 16/27

(57) ABSTRACT

Systems and methods are provided for receiving a first request of a plurality of requests at a first database server node for a first tenant of a plurality of database server nodes. The first database server node may reject the first request when it is determined to have a probability above a predetermined threshold. The rejected first request may be transmitted to a second database server node of the plurality of database server nodes.

### BACKGROUND

Currently, some network load balancing systems for database systems use centrally managed load balancing arrangements, such as a cluster-state directory (CSD). Nodes in centrally managed systems must register with the central state directory (e.g., CSD), and each node publishes their load information with the central state directory. When a new request arrives, the centrally managed load balancing system of the database determines which nodes are overloaded, and which loads are non-overloaded, and a node is selected from amongst the non-overloaded nodes to direct the request.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-2 how example methods of probabilistic bouncing for network load balancing for a database system according to implementations of the disclosed subject matter.

FIG. 3 shows an example of probabilistic load balancing according to implementations of the disclosed subject matter.

FIG. 4 shows an example computer system to perform the example methods of FIGS. 1-2 and the example shown in FIG. 3 according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter provide systems and methods of probabilistic bouncing for network load balancing, where requests may be rejected when the request has a probability that is determined to be above a predetermined threshold. For example, the network may be a cluster of database server nodes that may be load balanced using probabilistic bouncing.

Some multi-tenant database system configurations use a smaller number of database server nodes that have high core counts and large memory sizes. When there is a smaller number of database server nodes in a cluster for a database system, uneven load distributions across a cluster can have a high impact.

Implementations of the disclosed subject matter provide dynamic and reactive routing of database requests, as well as load balancing for such database system configurations. Using probabilistic bouncing, requests may be rejected by a database server node of a cluster when the request has a probability that is determined to be above a predetermined threshold. The request may be sent to the next node in the cluster that handles the tenant that the request is for.

The current trend for requests for a database system typically includes many requests over a short time with long pauses. Implementations of the disclosed subject matter may handle bursts of requests gracefully. Workload of the database server nodes is often not homogeneous. That is, users may send many requests over a short period of time, with long pauses in between. Using probabilistic bouncing described throughout, implementations of the disclosed subject matter allow requests to be handled by a database server node with a “warm” or “hot” cache to handle the requests, which are pre-populated with frequently accessed data. That is, data in response to the requests may be more quickly retrieved, resulting in faster database performance. The request is only bounced to the next database server node when the node cannot handle the request based on current load and determined probability.

Implementations of the disclosed subject matter improve upon load balancing systems that use a cluster-state directory (CSD) or other centrally managed load balancing system for a database system. In such systems, nodes need to register with the central system (e.g., CSD), and each node publishes their load information with the central system. When a new request arrives in such system, a hash of all registered nodes is performed to form two groups: (1) overloaded, and (2) non-overloaded. A node is selected with the smallest hash in the non-overloaded group. The disadvantages of such systems include the burden of having to maintain the central directory. Network delays may mean that the central directory does not have the most accurate information regarding the present load of the nodes in a cluster. Moreover, the central directory may be a single point-of-failure for the system. That is, if the central directory fails or is not operating normally, load balancing for the system will not work properly. By using the probabilistic bouncing of the disclosed subject matter, there is no need to keep track of the load of each node of the cluster. This may reduce system overhead (i.e., use of computational resources) and latency (i.e., delays in obtaining load information from each node) that are typically present when maintaining a central tracking system. In some implementations, the load of each node can be tracked by transmitting metadata with the bounced request to next node that includes tenant information and a state of one or more previous nodes.

Implementations of the disclosed subject matter load balance over a dynamic pool of database server nodes having a higher number of CPU cores and larger memory sizes when compared to traditional database server nodes. In some implementations, the number of database server nodes may change due to rolling redeployments and/or auto-scaling. New nodes may be included to the database cluster as early as possible, and old nodes may be gracefully shut down without the user noticing.

The probabilistic bouncing of the disclosed subject matter for load balancing may be “sticky” for a healthy node, which may be a database server node that is operating normally. That is, requests from a client may be routed to a single destination (i.e., a single database server node), instead of distributing traffic across multiple destinations. If a node is staying alive in the cluster, implementations of the disclosed subject matter may overrule any load balancing and route to that node to respond to the request.

Implementations of the disclosed subject matter may control a potential “blast radius” of a single tenant of a multi-tenant database system. The blast radius of the tenant may be the potential scope of impact if a single tenant of a database system receives a number of requests which exceeds a predetermined threshold for the database system. This may lead to having one tenant dominating the resources of the database system. For example, there may be many expensive requests (i.e., resource intensive requests) for a single tenant to be handled by the database cluster. The probabilistic balancing of the disclosed subject matter may be configured to withstand the many expensive requests. The database server nodes may have high processor core counts and large memory sizes compared to traditional database server nodes, and the probabilistic bouncing described throughout may be used to continue to direct requests to the node with the hot cache until a probability above a predetermined threshold is reached.

Implementations of the disclosed subject matter may be configured to scale the database system for one or more tenants, if needed. A service mesh may be used to scale the number of nodes for the database system. The service mesh may be a software layer that manages communication between services in an application and a database system. In some implementations, the database system may have interoperability with a system that automates deployment, scaling, and/or management of applications (e.g., Kubernetes™ or the like). The deployment state, service definitions, virtual service routes, and/or the entire service mesh of the database system may be modeled as resources (e.g., Kubernetes™ resources or the like).

Implementations of the disclosed subject matter may support multiple resource pools. Quarantining, mirroring, and/or segmentation are examples where workload isolation may be used. The load balancing of the disclosed subject matter may support dynamic resource pools. As there is no single coordinator for the database system of the disclosed subject matter, there are no single coordinator issues as with other systems and/or no cross-resource-pool failover needed.

Implementations of the disclosed subject matter may support availability zones. For example, routing in implementations of the disclosed subject matter may be availability zone aware, such that requests may reside in one availability zone. In this example, the requests residing in the one availability zone may not incur any cross-zone costs, such as latency and/or monetary cost.

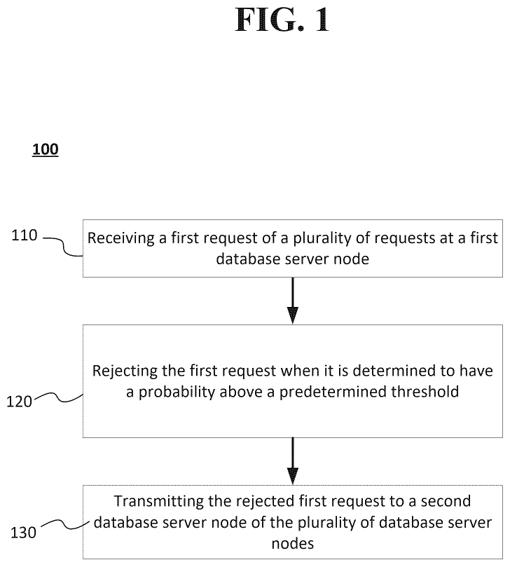

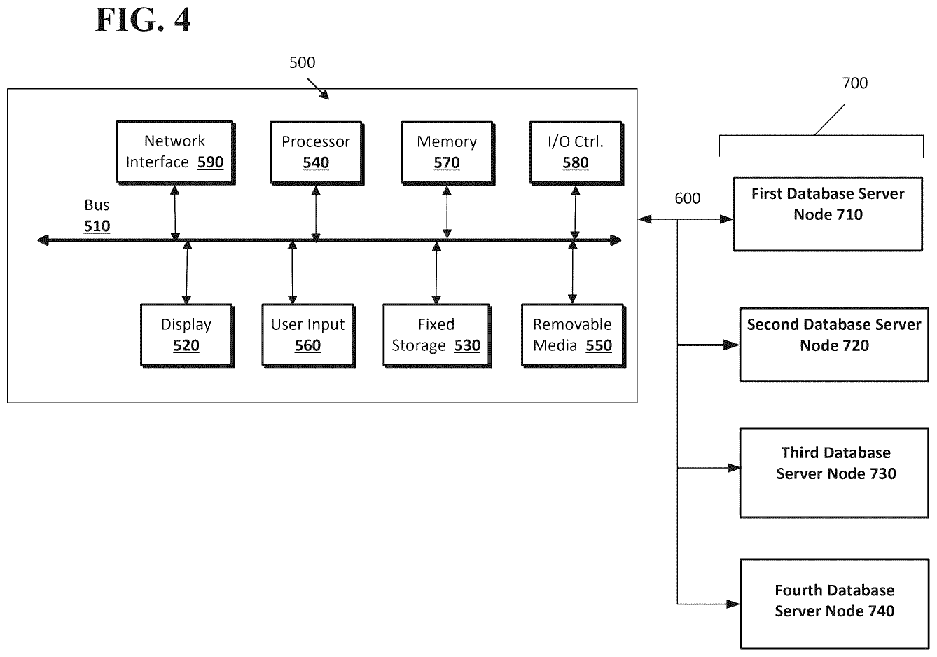

FIG. 1 shows example operations of method 100 of probabilistic bouncing for network load balancing of a database system according to implementations of the disclosed subject matter. At operation 110, a first request of a plurality of requests may be received at a first database server node for a first tenant of a plurality of database server nodes of a database system that comprise a cluster. For example, the first database server node may be first database server node 710 of cluster 700 shown in FIG. 4.

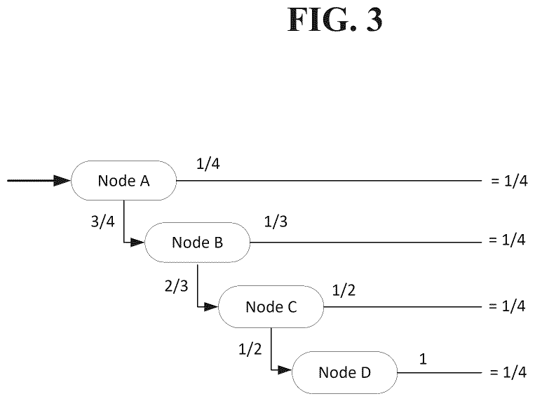

At operation 120, the first database server node may reject the first request when it is determined to have a probability above a predetermined threshold. For example, the first request may be rejected when it has a probability of (1/(maximum attempt spread value−attempt count +1)) when a current load of requests being processed by the first database server node is greater than a predetermined amount. The maximum attempt spread may be a total number of nodes of the plurality of database server nodes that are configured to process a request for the first tenant. The attempt count may be the number of database server nodes that have attempted to process the first request. An example of determining the probability using the equation above is discussed below in connection with FIG. 3.

At operation 130, the first database server node may transmit the rejected first request to a second database server node of the plurality of database server nodes. For example, the first database server node 710 may transmit the rejected first request to a second database server node 720 via the communications network 600 shown in FIG. 4.

In some implementations, the transmitting the rejected first request to the second database server node of the plurality of database server nodes at operation 130 may include transmitting the rejected first request to the second database server node of the plurality of database server nodes based on an ordered list of the plurality of database server nodes for the first tenant. For example, the ordered list may have an order of the first database server node 710, the second database server node 720, the third database server node 730, and the fourth database server node 740 shown in FIG. 4. In another example, the ordered list may have an order of the second database server node 720, the fourth database server node 740, the first database server node 710, and the third database server node 730. These are merely examples of ordered lists, and any suitable order of the database server nodes may be used.

In some implementations, the database system may be a multi-tenant database system having a plurality of tenants. The ordered list of database server nodes may differ based on a tenant of the plurality of tenants of the multi-tenant database system that a request of the plurality of requests is made for. For example, the database system that includes cluster 700 shown in FIG. 4 may have a plurality of tenants, and the ordered list of database server nodes (e.g., the first database server node 710, the second database server node 720, the third database server node 730, and the fourth database server node 740) may differ, based on the tenant that the request is for. Continuing this example, a first tenant may have a first ordered database server node list (e.g., the first database server node 710, the second database server node 720, the third database server node 730, and the fourth database server node 740) and a second tenant may have a different ordered list (e.g., the second database server node 720, the third database server node 730, the first database server node 710, and the fourth database server node 740). These are merely examples of different ordered lists for different tenants, and the lists of nodes may be different.

In some implementations, the transmission of the rejected first request to the second database server node at operation 130 may include transmitting metadata that includes identification of the first tenant, and/or state information of the first database server node with the first request. For example, the loads of one or more of the nodes may be tracked by transmitting metadata with the bounced request to next node. The metadata may include tenant information and/or a state of one or more previous nodes. Although there is no central tracing system for the probabilistic bouncing of the disclosed subject matter, information of the state of one or more nodes of the cluster may still be distributed. This is discussed in detail below in connection with FIG. 3.

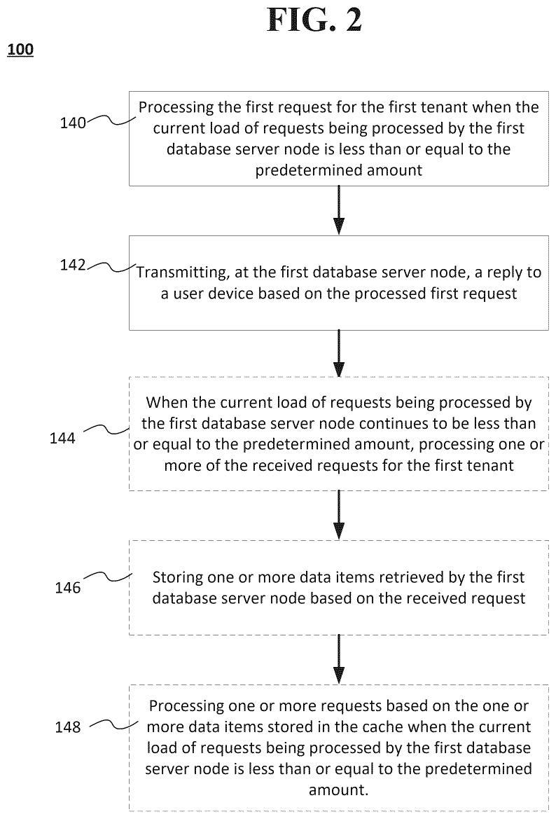

FIG. 2 shows additional example operations of method 100 according to implementations of the disclosed subject matter. At operation 140, when the current load of requests being processed by the first database server node is less than or equal to the predetermined amount, the first database server node may process the first request for the first tenant. At operation 142, the first database server node may transmit a reply to a user device (e.g., computer 500 shown in FIG. 4) based on the processed first request.

In some implementations, the first database server node may have a cache memory that is configured to store one or more data items retrieved by the first database server node based on the received request. At operation 144, when the current load of requests being processed by the first database server node continues to be less than or equal to the predetermined amount, the first database server node may process one or more of the received requests for the first tenant at the first database server node. That is, the first database server node may be used to process the request because of the determined probability of the request, and the cache may be pre-populated with frequently accessed data.

At operation 146, the cache memory of the first database server node may store one or more data items retrieved by the first database server node based on the received request. At operation 148, the first database server node may process one or more requests of the plurality of requests based on the one or more data items stored in the cache when the current load of requests being processed by the first database server node is less than or equal to the predetermined amount. By processing the request with the first database server node rather than with a different database server node, the pre-populated cache of the first database server node may quickly process the request more efficiently than a different database server node.

FIG. 3 shows an example of probabilistic bouncing for load management of a database system using method 100 described above according to implementations of the disclosed subject matter. As shown in FIG. 3, the example database system may have a cluster of nodes that includes Node A, Node B, Node C, and Node D. In some implementations, Node A may be first database server node 710 shown in FIG. 4, Node B may be second database server node 720 shown in FIG. 4, Node C may be third database server 730, and Node D may be fourth database server 740 shown in FIG. 4.

Implementations of the disclosed subject matter address a shortcoming of some load-balancing systems for databases, which is the degradation in the ability for the cluster in the database system to handle requests when overloaded. If there are more requests than the cluster can handle based on a load metric, all requests may hit the last nodes in the retry chains. These nodes (i.e., the last node in the path of nodes) are typically overloaded. Additionally, the overloaded nodes will be effectively taken out of the cluster for other tenants as well. As described throughout, implementations of the disclosed subject matter provide systems and methods of probabilistic request distribution to address this shortcoming. For example, the probabilistic request distribution may be implemented without a central management system, and may need to address the situation where the entire cluster is overloaded. With a traditional cluster-state directory, the central manager would know the status of the cluster as being overloaded.

In implementations of the disclosed subject matter, a database server node may reject a request with a probability using the equation:

(1/(maximum attempt spread value−attempt count+1))

when a current load of requests being processed by the first database server node is greater than a predetermined amount. As discussed above in connection with operation 120 of FIG. 1) the maximum attempt spread may be a total number of nodes of the plurality of database server nodes that are configured to process a request for the first tenant. The attempt count may be the number of database server nodes that have attempted to process the first request. For example, the database server node may reject the request having the determined probability of (1/(maximum attempt spread value−attempt count+1)) when the node is considered overloaded (e.g., has a load that is greater than 70%, greater than 75%, greater than 80%, greater than 85%, or the like).

In the example shown in FIG. 3, the maximum attempt spread may be 4 (i.e., as there are four example nodes), and the attempt count may be 1. Using the example equation above, there may be ¼ probability to accept the request, and ¾ probability to reject the request at Node A. At Node B, the maximum attempt spread may be 3 (as Node B, Node C, and Node D remain), and the attempt count may be 1, so the probability of accepting the request would be ⅓, and the probability of rejecting the request would be ⅔ using the equation above. At Node C, the maximum attempt spread may be 2 (as Node C and Node D remain), and the attempt count may be 1, so the probability of accepting the request may be ½, and the probability of rejecting the request may be ½ using the equation above. At Node D, the maximum attempt spread may be 1, and the attempt count may be 1, so the probability of accepting the request may be 1 using the equation above.

Implementations of the disclosed subject matter may be able to detect bursts of requests. The probabilistic bouncing described above may provide load balancing for such bursts, and does not depend on potentially out-of-date centralized load information for the cluster (e.g., centrally-located information about the nodes of the cluster, such as in a CSD system).

Implementations of the disclosed subject matter may determine over how many nodes a request should be distributed. Thus, the arrangements described above may provide a dynamic and configurable blast radius of tenants. The database server nodes may have high processor core counts and large memory sizes compared to traditional database server nodes, and the probabilistic bouncing described throughout may be used to continue to direct requests to the node with the hot cache until a probability above a predetermined threshold is reached. The order of database server nodes in the cluster of the database system may be configured. In some implementations, database server nodes may be added or removed from the cluster as needed. For example, a service mesh of the database system may determine whether to add or remove nodes.

The database system described above using probabilistic bounce may include other information into the request distribution. That is, when a request is “bounced” from one database sever node to another database server node as described above, the load information may be transferred along with the request. For example, a request may be bounced from a first database server node to a second database server node based on the load of the first database server node and the determined probability as described above. Load information of the first database server and/or the number of retries (i.e., number of attempts that a request has tried to be processed by a node) may be transmitted with the bounced request to the second database server node. That is, if load information may be carried between retries, the database system may correct load estimation.

In some implementations, the probabilistic bouncing described above may be integrated with CSD database systems to distribute loads among database server nodes of a cluster.

Current load balancing algorithms typically strive to maintain a coherent view on the load of all cluster members. The challenge of this approach is to keep the information within the CSD up to date. Every node is tasked to update its status in the CSD regularly, and the CSD has to reliably serve that information to the nodes with a low latency. The arrangement needs to protect itself against hard errors, such as nodes that failed to unregister. Nodes of the cluster that maintain a coherent cluster view quickly become hard-to-replace. Such nodes may be latency-sensitive points of failures for load balancing.

In some implementations of the disclosed subject matter described above, probabilistic bouncing may evenly distribute traffic across nodes once a predetermined load threshold is reached. This distribution may be without any knowledge of the loads of the other nodes, other than the total number of reachable nodes and the current position in a retry sequence. This means that every node individually may assume that, once overloaded, the previous nodes in the retry chain (i.e., the ordered list of the plurality of database server nodes as described above) are in a similar state.

In some implementations, the probabilistic bouncing described above may include tenant information and node-specific state data from one database server node to the next as part of the probabilistic bouncing. Whenever a request is bounced from a database server node of a cluster, the next database server node may have a chance to determine the state of the previous database server nodes. For example, the next database server node may determine the impact of the current tenant on other database server nodes. This may allow a database system to identify the case where one or more previous nodes were occupied by the same noisy tenant or not. A noisy tenant in a multi-tenant database system may be a single tenant that has activity which negatively impacts the performance of other tenants. Propagating additional state with probabilistic bouncing may contribute to service protection and/or fairness in a database system.

Implementations of the disclosed subject matter may be implemented in and used with a variety of components and network architectures. FIG. 4 shows an example database cluster 700 of a database system according to the disclosed subject matter which may perform method 100 shown in FIGS. 1-2 and the example shown in FIG. 3, and a computer 500 which may transmit requests to the database cluster 700 via a communications network 600. As discussed in further detail herein, the computer 500 may be a single computer in a network of multiple computers. The computer 500 may be a user device which may request data from one or more tenants that is stored in the one or more nodes of the database cluster 700. The database cluster 700 may include one or more database server nodes, such as first database server node 710, second database server node 720, third database server node 730, and/or fourth database server node 740. Although four database server nodes are shown, there may be fewer than or more than four database server nodes in the database cluster 700, as the number of database server nodes in FIG. 4 is merely an example.

In some implementations, the computer 500 may communicate with and may be used to transmit requests to the database cluster 700 and/or receive responses to requests from the database cluster 700 via communications network 600. The database server nodes (e.g., first database server node 710, second database server node 720, third database server node 730, and/or fourth database server node 740) of the database cluster 700 may be one or more hardware servers, virtual machines, cloud servers, databases, clusters, application servers, neural network systems, processors, devices, computers, or the like. The database server nodes (e.g., first database server node 710, second database server node 720, third database server node 730, and/or fourth database server node 740) may include and/or may be communicatively coupled to one or more storage devices, which may use any suitable combination of volatile and non-volatile physical storage mediums, including, for example, hard disk drives, solid state drives, optical media, flash memory, tape drives, registers, and random access memory, or the like, or any combination thereof. The database server nodes (e.g., first database server node 710, second database server node 720, third database server node 730, and/or fourth database server node 740) may store data, such as tenant data (e.g., in a multi-tenant database system), application data, and the like. The database server nodes (e.g., first database server node 710, second database server node 720, third database server node 730, and/or fourth database server node 740) may include one or more cache memory devices to store data. The access speed to the cache memory devices may be quicker than accessing data from the physical storage medium of the one or more storage devices that the database server nodes may be attached to.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 4 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving”, “rejecting”, “transmitting”, “processing”, “storing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
receiving a first request of a plurality of requests at a first database server node for a first tenant of a plurality of database server nodes of a database system that comprise a cluster;
rejecting, at the first database server node, the first request when it is determined to have a probability above a predetermined threshold; and
transmitting the rejected first request to a second database server node of the plurality of database server nodes.

2. The method of claim 1, wherein the probability is determined based on current load of requests, a maximum attempt spread, and an attempt count,
wherein the current load of requests being processed by the first database server node is greater than the predetermined amount, wherein a maximum attempt spread is a total number of nodes of the plurality of database server nodes that are configured to process a request for the first tenant, and wherein the attempt count is a number of database server nodes that have attempted to process the first request.

3. The method of claim 1, wherein the transmitting the rejected first request to the second database server node of the plurality of database server nodes comprises:
transmitting the rejected first request to the second database server node of the plurality of database server nodes based on an ordered list of the plurality of database server nodes for the first tenant.

4. The method of claim 3, wherein the database system is a multi-tenant database system having a plurality of tenants, and
wherein the ordered list of database server nodes differs based on a tenant of the plurality of tenants of the multi-tenant database system that a request of the plurality of requests is made.

5. The method of claim 1, wherein when the current load of requests being processed by the first database server node is less than or equal to the predetermined amount, the method further comprises:
processing, at the first database server node, the first request for the first tenant; and
transmitting, at the first database server node, a reply to a user device based on the processed first request.

6. The method of claim 5, further comprising:
storing, at a cache memory of the first database server node, one or more data items retrieved by the first database server node based on the received request.

7. The method of claim 5, wherein when the current load of requests being processed by the first database server node continues to be less than or equal to the predetermined amount, processing one or more of the received requests for the first tenant at the first database server node.

8. The method of claim 7, further comprising:
storing, at a cache memory of the first database server node, one or more data items retrieved by the first database server node based on the received request; and
processing, at the first database server node, one or more requests of the plurality of requests based on the one or more data items stored in the cache when the current load of requests being processed by the first database server node is less than or equal to the predetermined amount.

9. The method of claim 1, wherein the transmitting the rejected first request to the second database server node further comprises:
transmitting metadata that comprises at least one selected from a group consisting of: identification of the first tenant, and state information of the first database server node with the first request.

10. A system comprising:
a first database server node and a second database server node of a plurality of database server nodes of a database system that comprise a cluster,
wherein the first database server node is configured to:
receive a first request of a plurality of requests for a first tenant;
reject the first request when it is determined to have a probability above a predetermined threshold; and
transmit the rejected first request to the second database server node of the plurality of database server nodes.

11. The system of claim 10, wherein the probability is determined based on current load of requests, a maximum attempt spread, and an attempt count,
wherein the current load of requests being processed by the first database server node is greater than the predetermined amount, wherein a maximum attempt spread is a total number of nodes of the plurality of database server nodes that are configured to process a request for the first tenant, and wherein the attempt count is a number of database server nodes that have attempted to process the first request

12. The system of claim 10, wherein the first database server node transmits the rejected first request to the second database server node based on an ordered list of the plurality of database server nodes for the first tenant.

13. The system of claim 12, wherein the database system is a multi-tenant database system having a plurality of tenants, and
wherein the ordered list of database server nodes differs based on a tenant of the plurality of tenants of the multi-tenant database system that a request of the plurality of requests is made.

14. The system of claim 10, wherein when the current load of requests being processed by the first database server node is less than or equal to the predetermined amount, wherein the first database server node is further configured to:
process the first request for the first tenant; and
transmit a reply to a user device based on the processed first request.

15. The system of claim 14, further comprising:
a cache memory of the first database server node, wherein the cache memory is configured to store one or more data items retrieved by the first database server node based on the received request.

16. The system of claim 14, wherein the when the current load of requests being processed by the first database server node continues to be less than or equal to the predetermined amount, the first database server node is configured to process one or more of the received requests for the first tenant.

17. The system of claim 16, wherein the first database server node comprises a cache memory that is configured to store one or more data items retrieved by the first database server node based on the received request, and
wherein the first database server node is configured to process one or more requests of the plurality of requests based on the one or more data items stored in the cache when the current load of requests being processed by the first database server node is less than or equal to the predetermined amount.

18. The system of claim 10, wherein the first database server node that is configured to transmit the rejected first request to the second database server node is further configured to:
transmit metadata that comprises at least one selected from a group consisting of: identification of the first tenant, and state information of the first database server node with the first request.
